(19) United States
(12) Patent Application Publication
(10) Pub. No.: US 2002/0037956 A1
(43) Pub. Date: Mar. 28, 2002

(54) Latex polymers with good adhesion and surface tack over green cement

(76) Inventors: Kostas Savvas Avramidis, Apex, NC (US); Robert Scott Stannard, Apex, NC (US); Maynard Arthur Sherwin, Raleigh, NC (US)

Correspondence Address: UNION CARBIDE CORPORATION, Law Department E205, 39 Old Ridgebury Road, Danbury, CT, 06817-0001, US

(21) Appl. No.: 09/836,606

(22) Filed: Apr. 17, 2001

Related U.S. Application Data
(60) Provisional application No. 60/223,388, filed on Aug. 7, 2000.

(51) Int. Cl. C08K 3/00; B32B 27/00

(52) U.S. Cl. 524/523; 428/500

(57) ABSTRACT

Latex polymers and processes for producing the polymers are disclosed which can have enhanced surface tack over green cementitious substrates, i.e., those which are not fully cured, and other high pH substrates, while maintaining high levels of adhesion and tack. The latex polymers are polymerized from reduced amounts of carboxyl monomers, or no carboxyl monomers in the presence of a crosslinking agent.

### FIELD OF THE INVENTION

The present invention relates to latex polymer compositions and, more specifically, to latex polymer compositions having high surface tack over cementitious and other high pH substrates.

### BACKGROUND OF THE INVENTION

Latex polymer compositions used as adhesives are often of the pressure sensitive adhesive (“PSA”) type. PSA's are commonly comprised of (i) an all acrylic system with or without vinyl aromatic compounds such as styrene, e.g., polymers of methyl methacrylate, butyl acrylate or 2-ethylhexyl acrylate with small amounts of functional monomers, such as, for example, carboxylic acids or hydroxyl containing monomers; or (ii) vinyl acetate-based polymers usually containing lower alkyl acrylates, such as, for example, butyl acrylate.

Recently, PSA's have found a wide range of application in the fields of architectural coatings and interior decoration to bond coverings such as, for example, wallpaper, cloth, carpet and cushioned floors on cementitious and other high pH substrates. Typical adhesives used in these areas include solvent-based adhesives prepared by dissolving epoxy resins or rubbers such as natural rubbers or chloroprene rubbers in organic solvents and emulsion-based adhesives such as natural rubber latexes and vinyl acetate-based latexes and acrylic ester-based latexes. The solvent-based adhesives once gained widespread acceptance because of their high level of adhesion in the wet state, but have been used less in recent years because of the toxicity and flammability of the organic solvents. The PSA's are generally preferred because of their water-borne nature. However, latex adhesives have a common deficiency, i.e., loss of surface tack, which limits their use over “green” cementitious substrates (fresh cement which has not cured fully, i.e., been neutralized by CO₂ migration). As used herein, the term “cement” or “cementitious substrate” means a solid material comprising lime, alumina, silica, iron oxide or magnesia cured upon the addition of water which experiences a decrease in pH during the curing process. Examples of cementitious substrates include, for example, concrete, mortar, portland cement, cement wall board, cement patching and exterior insulation finishing systems (“EIFS”) base coats. Typically, green cement is alkaline, i.e., pH of greater than about 7.0, typically greater than about 10.0 or higher.

It is possible, of course, to allow the cementitious substrates to complete the curing process prior to applying adhesive to avoid this problem. However, during construction projects, it is often desirable to apply the coatings material, e.g., carpet, prior to the completion of the curing process to save time. Accordingly, latex polymer compositions are desired which are suitable for use over green cement. Desirably, the latex polymer compositions would be resistant to attack from plasticizers such as those commonly used in carpet backing materials.

### SUMMARY OF THE INVENTION

By the present invention, latex polymer compositions are provided which exhibit very high surface tack when applied over green cement or other high pH substrates, e.g., pH of about 10 or higher. Quite surprisingly in accordance with the present invention, it has been found that the reduction, and preferably absence, of carboxylic functional monomers in preparation of the polymers can enhance adhesion over green cement and other substrates containing high levels of mobile cations. Typically, the latex polymers of the present invention are polymerized from less than about 1 wt % of carboxylic acid monomer, e.g., acrylic acid. As a result, it is now possible to prepare latex polymer compositions suitable for use as PSA's that can have enhanced tack and adhesion over green cementitious substrates. Also, the latex compositions of the present invention can be used over cured cementitious substrates as well as non-cementitious substrates, e.g., wood, metal, glass and plastic.

In addition to the low acid content, the polymers of the present invention can demonstrate a high degree of resistance to plasticizer migration from coverings such as, for example, carpet backings.

Moreover, the present invention provides improved processes for the production of latex polymers that can have enhanced tack over green cementitious substrates. Typically, the latex compositions have a solids content usually in the range of 25 to 75 wt %, based on the total amount of latex polymer and water. In one preferred aspect of the invention, the processes provide a total solids content of at least about 50 wt %, more preferably above about 55 wt % and most preferably about 57 wt % or higher.

### BRIEF DESCRIPTION OF THE DRAWINGS

FIG. 1 illustrates Infrared Spectroscopy Absorbance of latex polymers containing carboxylic acid functionality.

FIG. 2 illustrates Infrared Spectroscopy Absorbance of latex polymers without carboxylic acid functionality in accordance with the present invention.

### DETAILED DESCRIPTION OF INVENTION

In accordance with the present invention, the latex polymers are polymerized from monomers comprising less than about 1 wt %, preferably less than about 0.5 wt % and more preferably less than about 0.1 wt % carboxyl monomers, based on the total weight of the monomers used to polymerize the polymer. Typical of such carboxyl monomers include, for example, acrylic acid, methacrylic acid, ethacrylic acid, crotonic acid, mesaconic acid, itaconic acid, maleic acid and fumaric acid.

High concentrations of multivalent cations, such as Ca, Al, Mg and others are often found in cement. Without being bound to any particular theory, it is believed that the metal ions present in cement migrate through the wet latex and associate with one or more carboxyl ions on the latex particle surface, thereby forming a crosslinked network which reduces its tack properties. Carboxylic monomers, such as acrylic or methacrylic acid, are typically included in PSA's for a variety of reasons, such as to increase the stability of the latex particles; to improve the adhesion of the resultant films to various substrates; to provide functional crosslinking sites for interparticle thermosetting reactions; and to control the viscosity of latex formulations via particle swelling upon neutralization. However, quite surprisingly, the latex polymer compositions of this invention can maintain excellent mechanical stability, even in the absence of carboxylic acids.

Representative vinyl monomers for use in the latex compositions of this invention include vinyl esters, such as, for example, vinyl laurate, vinyl decanoate, vinyl benzoates, and similar vinyl esters; vinyl esters of highly branched carboxylic acids having about 5 to 12 carbon atoms in the acid moiety, such as, for example, vinyl neo-nonanoate, vinyl neo-decanoate, vinyl neo-endecanoate, vinyl neo-dodecanoate, vinyl 2-ethylhexanoate and their mixtures; lower vinyl esters having from about 2 to 4 carbon atoms in the acid moiety, for example, vinyl acetate, vinyl isopropyl acetate, vinyl propionate and vinyl butyrate; vinyl aromatic hydrocarbons, such as, for example, styrene, methyl styrenes and similar lower alkyl styrenes, chlorostyrene, vinyl toluene, vinyl naphthalene and divinyl benzene; ethylenic hydrocarbons such as ethylene, propylene, butylene, isobutylene and higher alpha-olefins, vinyl aliphatic hydrocarbon monomers, such as, for example, vinylidene chloride as well as alpha olefins such as, for example, ethylene, propylene, 1,3 butadiene, methyl-2-butadiene, 1,3-piperylene, 2,3-dimethyl butadiene, isoprene, cyclohexane, cyclopentadiene, and dicyclopentadiene; and vinyl alkyl ethers, such as, for example, methyl vinyl ether, isopropyl vinyl ether, n-butyl vinyl ether, and isobutyl vinyl ether. Preferred vinyl monomers include vinyl neo-nonanoate, vinyl neo-decanoate, vinyl neo-endecanoate, vinyl neo-dodecanoate, vinyl 2-ethylhexanoate and their mixtures, styrene, and alpha-methyl styrene.

The latex polymers of the present invention typically comprise from about 0 to 40 wt %, preferably from about 2 to 30 wt %, and more preferably from about 5 to 20 wt % of vinyl monomers, based on the total weight of the monomers used to polymerize the polymer.

Representative acrylic monomers include any compounds having acrylic functionality. Preferred acrylic monomers are selected from the group consisting of alkyl acrylates, alkyl methacrylates, acrylate acids and methacrylate acids as well as aromatic derivatives of acrylic and methacrylic acid, acrylamides and acrylonitrile. Typically, the alkyl acrylate and methacrylic monomers (also referred to herein as “alkyl esters of acrylic or methacrylic acid”) will have an alkyl ester portion containing from 1 to about 12, preferably about 1 to 5 carbon atoms per molecule. Examples include methyl acrylate and methacrylate, ethyl acrylate and methacrylate, butyl acrylate and methacrylate, propyl acrylate and methacrylate, 2-ethyl hexyl acrylate and methacrylate, cyclohexyl acrylate and methacrylate, decyl acrylate and methacrylate, isodecyl acrylate and methacrylate, benzyl acrylate and methacrylate, and various reaction products such as butyl, phenyl, and cresyl glycidyl ethers reacted with acrylic and methacrylic acids, hydroxyl alkyl acrylates and methacrylates such as hydroxyethyl and hydroxypropyl acrylates and methacrylates, amino acrylates, methacrylates as well as acrylic acids such as acrylic and methacrylic acid, ethacrylic acid, alpha-chloroacrylic acid, alpha-cycanoacrylic acid, crotonic acid, beta-acryloxy propionic acid, and beta-styrl acrylic acid, such acids present in amounts not exceeding the amounts permitted in accordance with this invention. Preferred acrylic monomers include butyl acrylate and methacrylate, 2-ethylhexyl acrylate and methacrylate and hydroxyethyl and hydroxypropyl acrylates and methacrylates.

The latex polymers of the present invention typically comprise from about 60 to 100 wt %, preferably from about 70 to 98 wt %, and more preferably from about 80 to 95 wt % of acrylic monomers, based on the total weight of the monomers used to polymerize the polymer.

In addition to the specific monomers described above, those skilled in the art will recognize that other monomers such as for example, allylic monomers, can be used up in place of or in addition to the specifically described monomers in the preparation of the latex polymers. Further details concerning the selection and amounts of monomers suitable for use in preparing the latex polymers of the present invention are known to those skilled in the art.

Plasticization introduces pliability and distensibility into a plastic composition, generally by the addition of a liquid component called a plasticizer. Plasticizer migration takes place between two substances when there is a plasticizer concentration difference between the two substances. The solubility of a polymer in a plasticizer or solvent may be treated in the same manner as the miscibility of two liquids because amorphous (noncrystalline) polymers maybe considered liquids. Two liquids having minimal heats of mixing must have similar cohesive energy densities (“CED's”) to be miscible. The CED is the energy required to separate all the molecules of 1 cc of a liquid to an infinite distance against the action of intermolecular forces. Thus, CED=ΔE/V, where ΔE is the energy of vaporization and V is the molar volume of the liquid. The solubility parameter is defined as the square root of the CED, i.e., δ=(CED)^{½}. It has been shown in the art that a useful criterion for a resin to be soluble in a plasticizer or solvent is that its solubility parameter should be close to that of the plasticizer or solvent. The miscibility of a plasticizer and a polymer can be estimated using the polymer and plasticizer solubility parameters, δ, where the general rule of thumb is that materials with solubility parameters within 1.5 (cal/cm³) ^{½} will be miscible.

Plasticizer migration can take place, for example, in polyvinyl chloride (“PVC”) adhesive tapes where the plasticizer migrates from the tape to the adhesive, in carpet tile adhesives where the plasticizer migrates from the carpet backing to the adhesive and in painted caulks where the plasticizer migrates from the caulk to the paint. For example, the value of the solubility parameter of polyacrylic esters such as, polybutyl(acrylate), poly(methyl methacrylate), poly(ethyl acrylate), is in the 8.5 to 9.5 (cal/cm³)^{½} range and the solubility parameter of most phthalate plasticizers is in the 8.5 to 10.5 (cal/cm³)^{½} range. Accordingly, most plasticizers will migrate from the substrate to the adhesive resulting in adhesive transfer, an oily deposit at the interface, legging of the adhesive upon separation of the substrates and, generally, a change in the appearance of the adhesive.

Quite surprisingly, in accordance with the present invention, the latex polymer compositions can possess plasticizer resistance when the substrates to be adhered contain plasticizers e.g., carpet with carpet backing. Plasticizer resistance can be imparted to the polymer compositions of the invention by incorporating crosslinking agents without substantially detracting from its adhesive properties. Examples of crosslinking agents are silanes, acryl or methacryl polyesters of polyhydroxylated compounds, divinyl esters of polycarboxylic acids, diallyl esters of polycarboxylic acids, triallyl cyanurate, allyl acrylate, allyl methacrylate, diallyl terephthalate, N,N′-methylene diacrylamide, diallyl maleate, diallyl fumarate, hexamethylene bis maleimide, triallyl phosphate, trivinyl trimellitate, divinyl adipate, glyceryl trimethacrylate, diallyl succinate, divinyl ether, the divinyl ethers of ethylene glycol or diethylene glycol, ethylene glycol diacrylate, polyethylene glycol diacrylates or methacrylates, n-methylol acrylamide, n-isobutoxymethyl acrylamide, trimethylol propane triacrylate, pentaerythritol triacrylate, hexanediol diacrylate, neopentyl glycol diacrylate, divinyl benzene, tri or tetraethylene glycol diacrylate or methacrylate, the butylene glycol diacrylates or dimethacrylates and the like. The use of silanes is particularly preferred.

In a preferred embodiment for making a polymer possessing plasticizer resistance, γ-methacryloxypropyltrimethoxysilane (Silquest A-174, available from C. K. Witco, Middlebury, Conn.), or another crosslinking agent such as described hereinafter, is employed as a crosslinking agent. Such a polymer possesses high molecular weight, reflected by a gel content in the range of 30-80%, which in turn, imparts plasticizer resistance to the polymer.

Preferably, the amount of crosslinking agent is effective to provide a gel content of at least about 2%, preferably from about 30 to 80%. As used herein, the term “gel content” means the part of a polymer that remains insoluble after its film has been allowed to dissolve in tetrahydrofuran (THF) for 4 days. The weight of this insoluble polymer expressed as a percent of the original dry film weight is referred to herein as the percent gel content of the polymer.

The glass transition temperature, Tg, of the latex polymers of the present invention is typically in the range of −80 to 90° C., preferably −70 to 30° C., which can be achieved by the appropriate combination of the comonomers involved in the polymerization as known to those skilled in the art. The Tg of the latex polymers of the present invention used in PSA's is typically from −60 to −5° C., preferably from about −45 to −15° C. and more preferably from about −40 to −20° C. As used herein, the term “Tg” means polymer glass transition temperature. Techniques for measuring the glass transition temperature of polymers are known to those skilled in the art. One such technique is, for example, differential scanning calorimetry. A particularly useful means of estimating the glass transition temperature of a polymer is that given by the Fox equation,

1/Tg_{(polymer)}=x₁/Tg₁+x₂/Tg₂30 x_{3/}Tg₃+. . . +xₙ/Tgₙ (1)

where xᵢ is the weight fraction of component in the polymer and Tgᵢ is the homopolymer glass transition temperature of component i. For the preferred monomers of this invention these homopolymer glass transition temperatures are: butyl acrylate=−54° C., styrene=100° C., hydroxypropyl methacrylate=73° C.

The molecular weight of the latex polymers of the present invention is typically from about 20,000 to 700,000 grams per gram mole (“g/gmole”) and more typically from about 50,000 to 500,000 g/gmole. As used herein, the term “molecular weight” means weight average molecular weight. Techniques for determining weight average molecular weight are known to those skilled in the art. One such technique is, for example, gel permeation chromatography. The particle size of the latex polymers is not critical to the present invention. Preferably, the latex polymers have a particle size of from about 0.008 to 1.0, more preferably from about 0.015 to 0.5, and most preferably from about 0.15 to 0.35 microns.

The latex polymers of the present invention are typically in colloidal form, i.e., aqueous dispersions, and can be prepared by emulsion polymerization in the presence of a chain transfer agent and an initiator. The processes for preparing the compositions of the present invention are not critical and may be batch, semi-continuous or continuous. Specific details concerning procedures and conditions for emulsion polymerization are known to those skilled in the art. Typically, however, the polymerization is carried out in an aqueous medium at a temperature of from about 25 to 90° C.

A chain transfer agent may or may not be present during the polymerization depending on the balance of the adhesive properties required. If a chain transfer agent is present during the polymerization reaction, it is preferably present at a concentration of from about 0.01 to 5 wt %, preferably from about 0.1 to 1 wt % based on the total monomer content. Both water-insoluble and water-soluble chain transfer agents can be employed. Illustrative of substantially water-soluble chain transfer agents are alkyl and aryl mercaptans such as butyl mercaptan, mercaptoacetic acid, mercaptoethanol, 3-mercaptol-1,2-propanediol and 2-methyl-2-propanethiol. Illustrative of the substantially water-insoluble chain transfer agents include, for example, t-dodecyl mercaptan, phenyl mercaptan, pentaerythritol tetramercaptopropionate, octyldecyl mercaptan, tetradecyl mercaptan and 2-ethylhexyl-3-mercaptopropionate.

In carrying out the emulsion polymerization, an initiator (also referred to in the art as a catalyst) is preferably used at a concentration sufficient to catalyze the polymerization reaction. This will typically vary from about 0.01 to 3 wt % based on the weight of monomers charged. However, the concentration of initiator is preferably from about 0.05 to 2 wt % and, most preferably, from about 0.1 to 1 wt % of the monomers charged. The particular concentration used in any instance will depend upon the specific monomer mixture undergoing reaction and the specific initiator employed, which details are known to those skilled in the art. Illustrative of suitable initiators include hydrogen peroxide, peracetic acid, t-butyl hydroperoxide, di-t-butyl hydroperoxide, dibenzoyl peroxide, benzoyl hydroperoxide, 2,4-dicholorbenzoyl peroxide, 2,5-dimethyl-2,5-bis(hydroperoxy) hexane, perbenzoic acid, t-butyl peroxypivalate, t-butyl peracetate, dilauroyl peroxide, dicapryloyl peroxide, distearoyl peroxide, dibenzoyl peroxide, diisopropyl peroxydicarbonate, didecyl peroxydicarbonate, dicicosyl peroxydicarbonate, di-t-butyl perbenzoate, 2,2′-azobis-2,4-dimethylvaleronitrile, ammonium persulfate, potassium persulfate, sodium persulfate, sodium perphosphate, azobisisobutyronitrile, as well as any of the other known initiators. Also useful are the redox catalyst systems such as sodium persulfate-sodium formaldehyde sulfoxylate, cumene hydroperoxide-sodium metabisulfite, hydrogen peroxide-ascorbic acid, and other known redox systems. Moreover, as known by those skilled in the art, traces of metal ions can be added as activators to improve the rate of polymerization, if desired.

The particular surfactant useful for conducting the polymerization reaction is not critical to the present invention. Typical surfactants include anionic surfactants such as sodium lauryl sulfate, sodium tridecylether sulfate, diester sulfosuccinates and sodium salts of alkyl aryl polyether sulfonates; and nonionic surfactants such as alkyl aryl polyether alcohols and ethylene oxide condensates of propylene oxide, propylene glycol adducts.

The apparatus utilized to conduct the polymerization is not critical to the present invention and may include reactors such as, continuous stirred tank reactors, plug flow reactors, wet bed fluidized reactors with agitator and loop reactors. The details of suitable apparatus are known to those skilled in the art.

Cement powders typically used to make cementitious substrates include, for example, Portland cement, calcium aluminate, blast furnace slag, Portland/Pozzolan cement, Pozzolan cement, etc. Portland cement, typically conforming to ASTM C-150-55, is the result obtained by pulverizing a clinker comprising of hydraulic calcium silicates with additions of calcium sulfates. Other additives, may be interground with a clinker to alter cement properties. Portland/blast furnished slag cement, typically conforming to ASTM C205-53T, is a mixture comprising of silicates and aluminum silicates of calcium developed as a byproduct of iron production, and it is produced by rapidly chilling/quenching molten material in water, steam or air. Portland-Pozzolan cement, typically conforming to ASTM C-340-55T, is an interround mixture of Portland cement clinker and Pozzolan or a uniform blend of Portland/Pozzolan cement and fine Pozzolan. Calcium aluminate cement is a hydraulic cement with higher percentages of aluminate than Portland cement. The principal hydraulic component is calcium aluminate produced from clinker based on high aluminate containing material.

The reaction products comprising the latex polymers of the present invention typically have a solids, i.e., polymer, content of from about 25 to 75 wt %, preferably from about 45 to 65 wt % and more preferably from about 50 to 60 wt % based on the weight of the latex and water. Often, the solids content is above about 50 wt %, preferably above about 55 wt %, and more preferably about 57 wt % or higher.

The above described aspects of the present invention may be conducted in combination with each other or independently. In addition, a process during which the monomers can all be charged in the reactor at the start of the polymerizations, i.e., a batch process as opposed to semi-continuous (delay) addition can also be employed.

The latex polymer compositions of the present invention are useful wherever tack or adhesion are desired over cementitious substrates as well as other substrates. Preferably, films made from the polymers of the invention have a rolling ball tack value of 5 inches or less, more preferably 2 inches or less and most preferably 1 inch or less. Furthermore, after a period of one month, preferably 3 months and more preferably 6 months, the rolling ball tack value for a given film is preferably not more than 2 times and more preferably not more than 1.6 times the initial rolling ball tack value for the film. Furthermore, after a period of 6 months, preferably 12 months and more preferably 18 months, films applied from the latex of the invention over green cement substantially maintains its finger tack, i.e., a qualitative measurement of tackiness to a finger. As used herein, the term “rolling ball tack value” means the average distance in inches between the end of the incline plane and the point on a horizontal surface covered with the adhesive at which the ball stops after it has been released from the top of the incline. A description of the rolling ball method for measuring tack can be found in Example 2.

As a result of the improved tack, the latexes of this invention can be used for bonding a covering such as, for example, paper, roofing materials, surfacing materials comprising weather-resistant light-weight polymeric substrates, membranes, carpet, synthetic and inorganic fibrous cloths, rubber sheets, to cementitious or other substrates.

A preferred end use for the latex compositions of the present invention is as a PSA. In many cases, depending on the nature of the latex polymer, the PSA's are formulated with tackifiers, plasticizers, and curing agents to enhance adhesive properties. The PSA compositions are often modified with surfactants, defoamers, rheology modifiers to enhance application properties. A typical PSA end-use system consists of the adhesive, the carrier (polymeric or metallic film or paper backing) and, in many cases, silicone release liner. They find applications, for example, in tapes, labels, decals, floor tiles, wall coverings and wood grained film.

In another aspect of the invention, the polymer can be used as a laminating adhesive for two high pH surfaces.

In another aspect of the invention, the polymer glass transition temperature can be adjusted to provide a latex suitable for use as a sealer for floors, bridges, steel bars as such and impregnated in concrete structures and other metal surfaces for anti-corrosion and rust protection as known by those skilled in the art.

In another aspect of the invention the latex compositions can be used to suppress efflorescence. Efflorescence is a condition that occurs when soluble salts in the dried paint film or in the substrate migrate to the film surface during exposure. It exists both in isolated patches and over wide areas. Efflorescence is a major problem for the application of water-based paints over cementitious substrates. Concrete is a primary construction material but unfortunately concrete is not an ideal substrate for paints. The properties of concrete that can contribute to paint failures are: high alkalinity (surface pH of fresh concrete maybe as high as 12); high moisture content; high porosity; and rough, friable surface.

The following examples are provided for illustrative purposes and are not intended to limit the scope of the claims which follow. Weights are given in grams and percentages are given as wt %s unless otherwise stated.

The following ingredients were used in the Examples which follow.

| INGREDIENT | DESCRIPTION |
|---|---|
| Abex EP-110 | anionic surfactant of proprietary |
| | composition available from Rhodia, |
| | Cranbury, NJ |
| SVS | sodium salt of ethene sulfonic acid |
| | available from Air Products & |
| | Chemicals, Allentown, PA |
| Silquest A-174 | γ-methacryloxypropyltrimethoxy |
| | silane available from Witco |
| | Corporation, Greenwich, CT |

### EXAMPLE 1

### Preparation and Testing of Latex

A latex terpolymer of styrene, hydroxypropyl methacrylate and butyl acrylate was prepared according to the formula and procedure given below. All amounts refer to the materials as such, i.e., without adjustment for their solids content.

| Ingredient | grams |
|---|---|
| Monomer mix | |
| Butyl acrylate | 1015.74 |
| Styrene | 78.96 |
| Hydroxypropyl methacrylate | 33.84 |
| Abex EP-110 | 63.36 |
| Tetrasodium Pyrophosphate | 1.43 |
| Sodium Vinyl Sulfonate | 20.23 |
| Deionized water | 279.78 |
| t-dodecyl mercaptan | 0.89 |
| Initial Monomer | Varies |
| Initial charge | |
| Deionized water | 373.95 |
| Initial Catalyst | |
| Deionized water | 23.85 |
| Ammonium persulfate | 2.39 |
| Sodium bicarbonate | 0.38 |
| Fed Catalyst | |
| Deionized water | 35.11 |
| Ammonium persulfate | 4.58 |
| Sodium Bicarbonate | 0.57 |
| Post Heat: At 70 C. for 50 minutes | |
| Post additions | |
| Post-Catalyst-Oxidizer | |
| Deionized water | 10.0 |
| t-butyl hydroperoxide (70%) | 2.39 |
| Post-Catalyst-Reducer | |
| Deionized water | 10.0 |
| Sodium Formaldehyde Sulfoxylate | 1.62 |
| Polymerization Temperature: 85 C. | |
| Feed Time: 250 minutes | |

The monomer mixture was prepared by charging water, the surfactant and the appropriate amount of each of the above monomers to a monomer mix container, and mixing the contents using a variable speed agitator. Initially, water was charged to the reactor, the agitator speed was set to the desired setting, usually 200 rpm and the reactor temperature was raised to the desired setting. Following this conditioning of the reactor the initial monomer was added to the reactor and was allowed to mix for 10 minutes. Once the mixing step was completed, the initial initiator was added to the reactor. The reactor temperature increased as a result of the exotherm due to the polymerization of the initial monomer charge. After the exotherm, and when the reactor temperature was at 85 C., the emulsified monomer mixture and the fed catalyst both commenced at the same time. The polymerization temperature was controlled at 85 C. during the 4-hour monomer feed addition. When all the feeds were finished, the reactor temperature was gradually lowered and the reactor contents were allowed to further react for 50 minutes in order to facilitate residual monomer reduction. After this post-heat step, the post-catalysis step started. Post-oxidizer and post reducer solutions were fed over a period of 30 minutes in order to ascertain that residual monomer levels were within specification limits. After the post-catalysis was completed the reactor was cooled to below 30° C. When the residual monomer levels were within specification, the product was recovered.

Table 1 lists typical properties of the terpolymers made by the process of Example 1. The process of this invention results in clean high solids latexes with minimal grit and scrap. Latexes of different polymer compositions were made following the general procedure of Example 1. The latexes were evaluated for surface tack and plasticizer migration resistance.

TABLE 1
Physical Properties of the Latexes made by the process of Example 1

| | | | | Viscosity, | | |
|---|---|---|---|---|---|---|
| | Tot. | | Particle | cp (LVT, | Filterables, | Agitator |
| | Solids, | | Size, | spindle | ppm | Scrap |
| Run | (%) | pH | (microns) | #3, 60 rpm) | (40/100 mesh) | (g) |
| A | 58.3 | 2.3 | 0.223 | 540 | 1/30 | 0.84 |
| B | 57.9 | 2.2 | 0.214 | 340 | 3/37 | 0.49 |
| C | 59.4 | 2.2 | 0.237 | 360 | 7/30 | 0.97 |

### EXAMPLE 2

### Surface Tack Over Green Cement

Some of the latexes described above have been tested for their surface tack over green cement. Testing was completed utilizing a commercially available cement patching compound. The cement patch was mixed in accordance with the manufacturers recommendations. A ½ of a 12′ by 12′ section of substrate was coated with the patching compound. Drawdowns of the latex were applied after the cement was allowed to cure for six hours. A number of different drawdown thicknesses were evaluated, and found not to effect the tack of the dried latex. The drawdown covered both the substrate over the cement-coated and uncoated portion of the substrate.

Tack was evaluated based on a skilled technician's evaluation of the feel of the dried surface (finger tack). It was also determined by a Rolling Ball test according to ASTM standard D3121. In the determination of tack by the rolling-ball method, a steel ball is released at the top of an incline, allowed to accelerate down the incline and roll on to a horizontal surface covered with the pressure sensitive adhesive. Tack is determined by measuring the distance that the ball travels across the adhesive before stopping. A large distance implies low tack and a short distance reflects high tack. The results of the tack over green cement are listed in Table 2. Latexes with pH in the range of from 2 to 8 were evaluated. The polymers of this invention exhibited excellent surface tack over green cement.

TABLE 2

| | | | | | |
|---|---|---|---|---|---|
| | Butyl | | | Rolling Ball | Finger |
| | Acrylate | Acid | | Tack, Over | Tack Over |
| | parts | Content, | Tg, | Glass | Green |
| Run | (wt %) | (wt %) | C | (inches) | Cement |

Rolling-Ball Tack of Polymers made by the process of Example 1

| | | | | | |
|---|---|---|---|---|---|
| A | 82 | 0 | −38 | 1.5 | v. good |
| B | 90 | 0 | −46 | 0.5 | v. good |
| C | 90 | 8 | −44 | 0.5 | none |

Finger Tack Over Green Cement After 18 months

| | | | | |
|---|---|---|---|---|
| B | 90 | 0 | −46 | v. good |

### EXAMPLE 3

### Latexes With Good Plasticizer Migration Resistance in Tile Adhesives

Latex polymers made using the general procedure of Example 1 with no chain transfer agent but with a crosslinking agent incorporated during the polymerization were found to possess good plasticizer migration resistance. Accordingly, we have surprisingly found out that when γ-methacryloxypropyltrimethoxy silane (Silquest 174) is incorporated in the polymer during the polymerization, the polymers exhibit excellent plasticizer resistance when used as adhesives in carpet tile applications. Silanes act as multifunctional monomers and serve to crosslink the polymer during polymerization, thus greatly raising the molecular weight of the latex so much so that the polymer possesses gel content.

Plasticizer migration resistance was determined by the following test. The back surfaces of two carpet tiles were coated with latex and were then allowed to dry. Subsequently, the two tiles were secured back-to-back using a rubber band and aluminum foil. These samples were then placed in an oven at 35 C. for two weeks after which they were removed from the oven and were peeled apart. The plasticizer migration resistance was rated on a scale of 1 to 10, where 1 was complete failure as noted by legging of the adhesive, an oily deposit at the interface and, in general, a change in the adhesive appearance (the adhesive became gooey) and a rating of 10 for an easy separation of the two carpet tiles with no transfer or legging of the adhesive.

Table 3 lists the plasticizer resistance and the gel content of latexes made by the process of the present invention for different levels of γ-methacryloxypropyltrimethoxy silane (Silquest A-174).

TABLE 3
Plasticizer Migration Resistance and Polymer Gel
Contents for Different Silane Levels.

| Silquest A-174, | Gel Content, | Plasticizer |
|---|---|---|
| ppmw | % | Resistance |
| 0 | 0 | 4 |
| 250 | 1.8 | 8 |
| 500 | 1.9 | 8 |
| 750 | 33.9 | 8 |
| 1000 | 45.0 | 9 |
| 1000 | 50.5 | 9 |
| 1250 | 58.3 | 9 |
| 1500 | 49.8 | 9 |
| 2000 | 57.2 | 9 |

In the absence of a crosslinking agent, (i.e., 0 ppm Silquest A-174) the polymer possesses no gel content and plasticizer migration resistance is poor, a rating of 4 in Table 3. At gel contents of about 45% the polymer exhibits excellent plasticizer resistance in carpet tile applications as indicated by the rating of 9 in Table 3.

### EXAMPLE 4

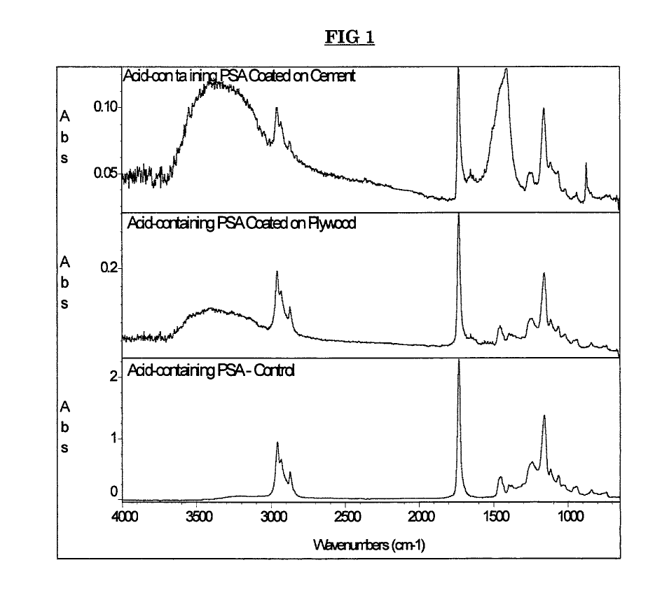

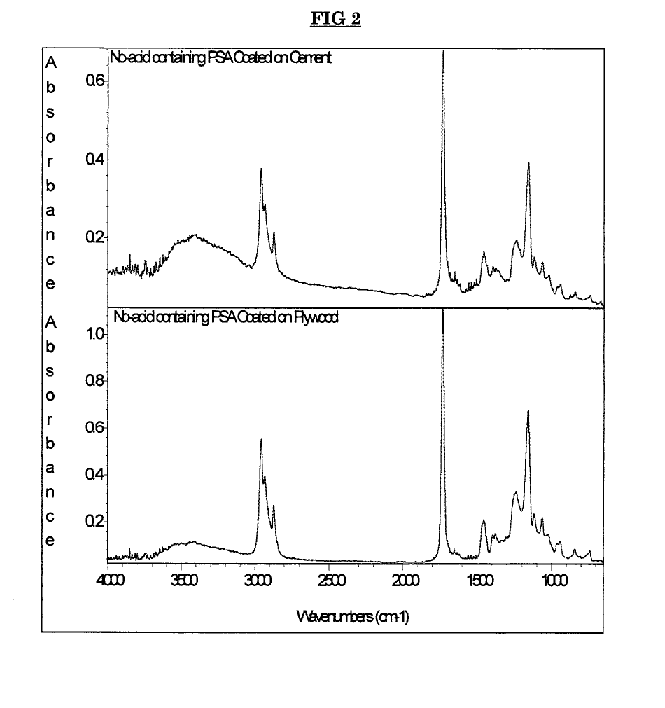

We have examined by Fourier Transform Infrared Spectroscopy (FTIR) films of two pressure sensitive adhesive latexes, one that contains carboxylation and the second with no carboxylation. The latexes were coated on plywood and cement substrates. The acid-containing latex shows calcium carbonate absorbance peaks at wavenumbers of 3500 cm⁻¹, 1450 cm⁻¹ and 875 cm⁻¹. The no acid-containing latex shows no peaks at the calcium carbonate wavenumbers. The scans of the samples are shown in FIGS. 1 and 2. The acid-containing PSA coated on the cement substrate lost all its surface tack and it also became hazy whereas the no acid-containing PSA coated on cement had excellent surface tack. All the samples showed evidence of a small amount of water.

A number of commercial latexes were tested for their surface tack over green cement substrates and were found to be unsuitable. For example, several commercial PSA latexes with different carboxylation levels were tested and were found to possess no surface tack at all. These are listed in Table 4.

TABLE 4
Tack of Acrylic Latexes over Fresh Cement

| Acrylic | Acid Content, | Tack over |
|---|---|---|
| Latex | wt % | Green Cement |
| C | 1 | None |
| D | 1 | None |
| E | 4 | None |
| F | 3 | None |
| G | 3 | None |
| H | 8 | None |

Although the present invention has been described with respect to specific aspects, those skilled in the art will recognize that other aspects are intended to be included with the scope of the claims which follow.

1. A latex polymer polymerized from monomers comprising,
(a) from about 0 to 40 wt % of one or more vinyl monomers; and
(b) from about 60 to 100 wt % of one or more acrylic monomers, said percentages based on the total weight of monomers used to polymerize the polymer: characterized in that;
(i) the polymer is polymerized from less than about 1 wt % of carboxyl monomer; and
(ii) the polymer is polymerized from an effective amount of a crosslinking agent to provide a gel content of at least 2%.

2. The latex polymer of claim 1 wherein the vinyl monomer is styrene.

3. The latex polymer of claim 1 wherein the vinyl monomer is selected from the group consisting of vinyl neo-nonanoate, vinyl neo-decanoate, vinyl neo-endecanoate and vinyl neo-dodecanoate and mixtures thereof.

4. The latex polymer of claim 1 wherein the acrylic monomer is selected from the group consisting of butyl acrylate, butyl methacrylate, 2-ethylhexyl acrylate, ethylhexyl methacrylate, hydroxyethyl acrylate and hydroxypropyl acrylate, hydroxypropyl methacrylate and mixtures thereof.

5. The latex polymer of claim 1 wherein the polymer has a gel content of from about 30-80%.

6. The latex polymer of claim 1 wherein the crosslinking agent is a silane.

7. A film made from the latex polymer of claim 1.

8. The film of claim 7 which has a rolling ball tack value of 5 inches or less.

9. The film of claim 8 which has a rolling ball tack value of 2 inches or less.

10. The film of claim 7 which substantially retains finger tack over green cement after 6 months.

11. A method of bonding a covering material to a green cementitious substrate, comprising:
(a) applying an adhesive composition comprising the latex polymer of claim 1 to at least one of a surface of the green cementitious substrate or a surface of the covering material; and
(b) contacting the covering material with the green cementitious substrate such that the adhesive composition is disposed between, and in contact with, the covering material and the cementitious substrate.

12. The method of claim 11 wherein the cementitious substrate has a pH of 10 or higher.

13. The method of claim 11 wherein the cementitious substrate is selected from the group consisting of cement, concrete, cement wall board, mortar, cement patching and exterior insulating finishing systems base coats.
